(19) United States
(12) Patent Application Publication
(10) Pub. No.: US 2023/0281673 A1
(43) Pub. Date: Sep. 7, 2023

(54) METHOD AND SYSTEM FOR IDENTIFIYING ASSETS AND AUTOMATING THE CREATION AND MONETIZATION OF ADVERTISEMENTS

(71) Applicant: TLYNT Inc., Los Angeles, CA (US)

(72) Inventors: Sameer Mohan Gupta, Las Vegas, NV (US); Jonathan Richard Biebl, Los Angeles, CA (US); Thomas Young, Orinda, CA (US)

(21) Appl. No.: 18/195,600

(22) Filed: May 10, 2023

Related U.S. Application Data
(63) Continuation of application No. 17/957,163, filed on Sep. 30, 2022.
(60) Provisional application No. 63/255,141, filed on Oct. 13, 2021.

(51) Int. Cl. G06Q 30/0241; G06Q 30/0273

(52) U.S. Cl. CPC G06Q 30/0276; G06Q 30/0273; G06Q 30/0277

(57) ABSTRACT

A machine-implemented method for generating one or more advertisements has an emphasis upon predictive formulation of advertisements having features or elements which are associated with or identified by tags, and where the process of generating ads is modified, such as based upon monitored engagement of displayed ads, for use in optimizing the advertisement creation process. The method is implemented by a model-driven advertisement generator which utilizes templates and rules to select assets defined by tags in order to generate advertisements which are defined by collections of associated tags.

### RELATED APPLICATION DATA

This application is a continuation-in-part of U.S. application Ser. No. 17/957,163, filed Sep. 30, 2022, which claims priority to U.S. Provisional Patent Application Ser. No. 63/255,141, filed Oct. 13, 2021, and incorporates by reference said applications as if set forth fully herein.

### FIELD OF THE INVENTION

The present invention relates to identifying assets and automating the creation and monetization of advertisements using such assets.

### BACKGROUND OF THE INVENTION

While many advances have been made in the digital advertisement industry, the traditional advertisement industry, which includes but is not limited to print, television, radio and billboards, has not advanced at the same rate. Sourcing assets, including but not limited to people, places, pets and objects, is a relatively manual process which involves the compilation of images, a manual selection process, the coordination with talent and/or owners, and an onerous payment process. Sometimes the cost of the resources necessary to find, book, manage and pay for an asset (for example a non-union firefighter for a commercial TV shoot) approaches or exceeds the cost of the asset itself. Advertisers use a combination of agencies and casting companies, which in turn find other companies that can assist in the sourcing of assets, including people, places, pets and objects. On top of the costs for one or more companies to do this work, the time it takes can be considerable. For example, if a business is looking for 20 “real people” talent (a.k.a. average persons that are non-union actors) for a commercial, that business may spend 10 to 100 hours at a cost of $100 to $500 per hour, equaling $1,000 to $50,000, when the cost of the talent is only $20,000 (20 times $1,000). In other cases, advertisers pay a flat commission of 20% or more for this task, which often involves sifting through Dropbox folders of pictures of people and emailing/texting/speaking to agencies. The asset pool is limited in size and difficult to manage. Meanwhile there are millions of people in the “gig economy” that are interested in being in a commercial and getting paid for their time and service.

Additionally, conventional methods of advertisement content creation may not be able to benefit from current advances in digital technology. Conventional advertisements are storyboarded, reviewed in focus groups, and created in a similar manner to decades ago. There is no easy way to get a sample advertisement into the digital market to test its efficacy before spending substantial money in the creation of the ad. Think of a main actor in a commercial. Before being cast, the actor must either be a celebrity with a known engagement, or a risky newcomer who the creative team “believes in” but has little data to support their prominent role until after the commercial airs.

Lastly, the content creation process is timely and expensive. Making a new advertisement of any type takes time and resources including but not limited to creative agencies, graphics designers, actors and real people talent, shoot locations, props, audio-video equipment and editing software. In a world withe apps that allow for the quick-and-easy creation of semi-professional photographs, we are still creating ads like we were before digitization: by hiring people to create storyboards of concepts, which are approved through focus groups and the opinions of stakeholders, and are then produced at substantial cost before being disseminated through multiple advertising channels.

A system and method to better source assets, test content, and create and optimize advertisements is desired.

### SUMMARY OF THE INVENTION

Embodiments of the invention comprise systems and methods for intelligently generating advertisements. One embodiment of the invention comprises a machine-implemented method for generating one or more advertisements, with an emphasis upon predictive formulation of advertisements having features or elements (such as assets) which are associated with or identified by tags, and where the process of generating ads is modified, such as based upon monitored engagement of displayed ads, for use in optimizing the advertisement creation process.

In one embodiment, an intelligent system for generating an advertisement, comprises: a data storage device; digital information stored in the data storage device, the digital information comprising a plurality of advertising assets each designated by a tag; a plurality of advertisement templates; and a plurality of advertisement rules; and a processing device, coupled to the data storage device, to execute a model-driven advertisement generation tool, wherein the advertisement generation tool is configured to: receive input regarding one or more advertisement characteristics; select one of the plurality of advertisement templates based upon the one or more advertisement characteristics; select, using the advertisement template and one or more of the plurality of rules, a plurality of the advertising assets utilizing information associated with the tags; and generate at least one advertisement utilizing the tags, the advertisement template and the one or more of the plurality of rules, wherein the at least one generated advertisement is defined by a relationship of the utilized tags.

In one embodiment, each tag has at least one associated selection value, such as where each tag has a plurality of selection values in relation to different of the advertisement templates. In this embodiment, the model-driven advertisement generation tool is configured to select the tags at least in part based upon the selection values associated with the tags. The at least one generated advertisement may have a temporal component, where the advertisement is defined by a relationship of the utilized tags at different times.

In one embodiment, the model-driven advertisement generation tool receives advertisement engagement information and utilizes the advertisement engagement information to update existing advertisements, the one or more templates, the advertisement rules, and the selection values for the tags.

In one embodiment, the model-driven advertisement generation tool comprises a generator component and a discriminator component, the generator component configured to generate one or more proposed advertisements using a first one or more of the plurality of rules, and the discriminator configured to determine acceptability of the one or more proposed advertisements as the generated advertisement based upon compliance with a second one or more of the plurality of rules.

In one embodiment, the model-driven advertisement tool further implements an advertisement optimization engine which is configured to receive ad engagement information received from presentation of the at least one generated advertisement and utilize the advertisement engagement information to modify the at least one generated advertisement by selection of one or more alternate tags to comprise the at least one generated advertisement.

Further objects, features, and advantages of the present invention over the prior art will become apparent from the detailed description of the drawings which follows, when considered with the attached figures.

### DESCRIPTION OF THE DRAWINGS

FIG. 1 illustrates an exemplary environment of use of an automated advertisement system;

FIG. 2 is a flow diagram of methods of embodiment of the automated advertisement system from the advertiser-end;

FIG. 3 is a flow diagram of methods of embodiment of the automated advertisement system from the asset provider end using passive matching;

FIG. 4 is a flow diagram of methods of embodiment of the automated advertisement system from the asset provider end using active search;

FIGS. 5-8 are exemplary user interfaces;

FIG. 9A illustrates another exemplary environment of use and associate implementation flow of an AI-implemented method of generating advertisements;

FIG. 9B illustrates additional aspects of the method flow shown in FIG. 9A;

FIGS. 10A and 10B illustrate aspects of an advertisement in accordance with the invention;

FIG. 11 illustrates aspects of an asset data table in accordance with the invention; and

FIG. 12 illustrates aspects of an advertisement data table in accordance with the invention.

### DETAILED DESCRIPTION OF THE INVENTION

In the following description, numerous specific details are set forth in order to provide a more thorough description of the present invention. It will be apparent, however, to one skilled in the art, that the present invention may be practiced without these specific details. In other instances, well-known features have not been described in detail so as not to obscure the invention.

The present invention is an automated advertisement system and method to streamline the advertisement creation process using artificial intelligence (“AI”) and other technology. Specifically, advertisers with a need to create one or more advertisements may be automatically matched to asset providers who may provide assets to be used in the advertisement. The automated advertisement system may also create and optimize advertisements with iterative redesign based on quantifiable market feedback and payments to assets based on digital contracts like non-fungible tokens.

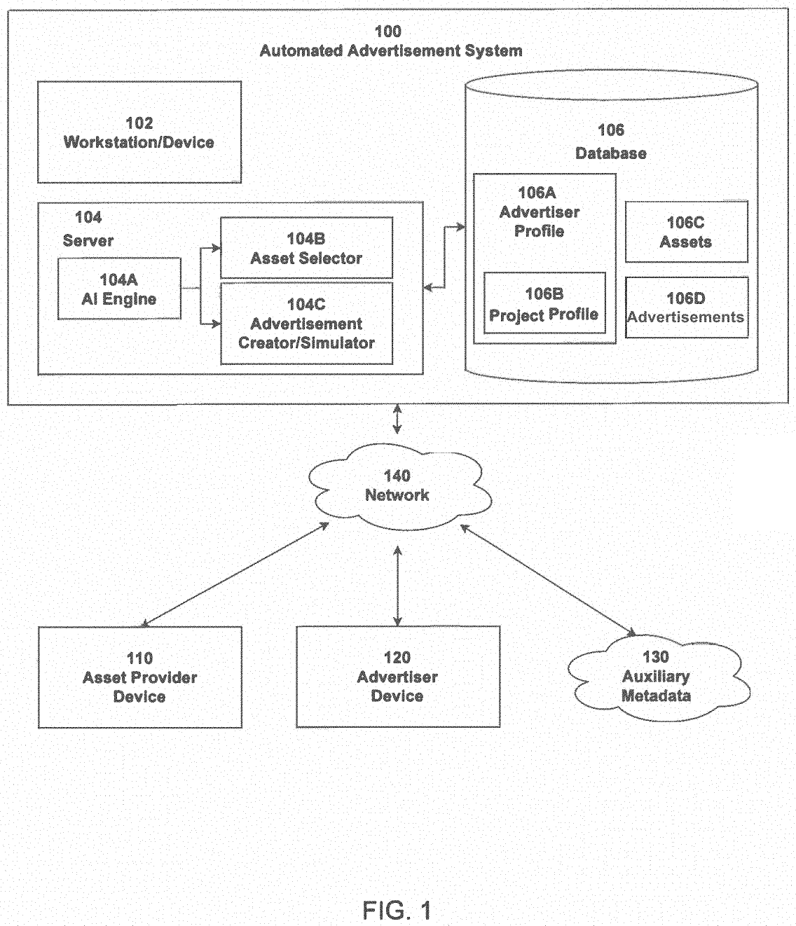

FIG. 1 illustrates an exemplary environment of an automated advertisement system in connection with advertisers and asset providers. In FIG. 1, an automated advertisement system 100 may be in communication with a number of advertiser devices 110 and asset provider devices 120, via a network 130 (such as the Internet). Advertiser devices 110 and asset provider devices 120 may be any user device such as a smartphone, a tablet, a smartwatch, a personal computer, or any other type of electronic computing device. Additional resources such as auxiliary data and metadata 140 on websites, servers, database, or clouds may also be accessible via the network 130.

The automated advertisement system 100 may include a plurality of workstations and user devices 102, at least one server 104 which comprises one or more processors or controllers, at least one communication device or interface, a database or other data storage device 106, and one or more additional memory or data storage devices (such as separate from the database). In one or more embodiments, the processor(s) is configured to execute one or more instructions, such as in the form of machine readable code (i.e. “software”), to allow the server 104 to perform various functions. The software is preferably non-transitory, such as by being fixed in a tangible medium. For example, the software may be stored in the one or more memory devices. One or more of the memory devices may be read-only. In addition, the software may be stored on a removable medium in some embodiments. In general, the one or more memory devices are used as temporary storage. For example, the one or more memory devices may be random access memory or cache memory used to temporarily store some user information and/or instructions for execution by the at least one processor.

The software may comprise one or more modules or blocks of machine-readable code. Each module may be configured to implement particular functionality when executed by the one or more processors, and the various modules may work together to provide overall integrated functionality. Of course, in certain embodiments, it is also possible for various of the functionality to be implemented as hardware, i.e. a processor or chip which is particularly designed to implement various of the functionality described herein.

In one embodiment, the server 104 may include (or be linked communicatively at one or more times to) one or more input and/or output devices, such as a keyboard, mouse, touchscreen, video display or the like, whereby the processor may receive information from an operator or servicer of the server 104 and/or output information thereto. This allows, for example, an operator of the server 104 to interface with the server 104 to upgrade, maintain, monitor, etc. In other embodiments, an operator might interface with the server 104 via a separate workstation or other devices 102.

In one embodiment, the processor and other elements of the server 104 may be linked and thus communicate over one or more communication buses. In this manner, for example, the processor may read/receive software from the memory for execution, receive inputs and provide outputs to the various I/O devices, receive information from or output information to external devices via the communication interface, etc. The one or more communication devices or interfaces permit the server 104 to communicate with the one or more workstations and devices 102, and preferably external devices, networks, systems and the like.

The automated advertisement system 100 may, via server 104 (there may be a plurality of different servers which each implement different functionality) be configured to implement a variety of functionality, including but not limited to account matching, advertisement creation, data gathering and analysis, and payment processing. These features will be discussed in more detail below. The automated advertisement system 100 may include a wide variety of other features and elements, including but not limited to an accounting system, a user tracking system, a reporting system, and the like.

The automated advertisement system 100 allows advertisers to efficiently create advertisements by simplifying the underlying asset sourcing, selection and iterative creation process, and allows advertisers to automatically create advertisements or concepts for advertisements that are optimized through artificially-intelligent testing of the ads on digital and traditional ad platforms.

As indicated, the automated advertisement system 100 comprises a database 106, which may include at least one database or dataset including, but not limited to, advertiser profiles 106A, project profiles 106B, assets 106C, and advertisements 106D. In one embodiment, project profiles 106B may be a database or dataset within the advertiser profiles 106A database or dataset.

In one embodiment, assets 106C comprise a database of assets for use in creating advertisements. The assets may comprise, for example, images, sound files, videos and the like. As described in more detail below, the assets may be provided (such as uploaded) by one or more asset providers and/or may be collected from one or more sources, such social media accounts of asset providers.

As further described below, the assets which are associated with the database 106 may be tagged with one or more tags. The tags may comprise identifiers or information, such as may be searched with a search engine. For example, the tags may comprise information which identifies the asset, such as by type (person/animal/object), and various sub-types or categories (male/female; hair color, hair style, etc.). As described below, the tags may also comprise time and/or location stamps. The timestamps may include a time that the asset was created (e.g. when a photo or video was taken), and/or the time the asset was associated with the database 106. The location stamp may include a location at which the asset was created (such as associated with a photo or video when taken). The time and/or location stamps may be automatically generated and associated with an asset (such as a photo taken with a smartphone; wherein the times information may be extracted from the photo) or might be added, such as manually. For example, where a photograph does not include embedded location information, the asset provider might be prompted to input location information by the system 100.

In one embodiment, the tag may be created from information provided by the asset provider. For example, if an asset provider uploaded an image of their dog, the asset provider might provide identifying information such as: dog/Labrador/black/male/puppy. In other embodiments, the server may be configured to generate tag information. For example, the server may apply image analysis to an image in order to obtain information from the image which is used to tag the asset. In this manner, a comprehensive database 106 of advertising assets is generated, where the assets are, in the manner described below, searchable and usable in the generation of one or more advertisements. Further, in that the assets are provided by asset providers, advertisers can readily use the assets associated with the database without having to individually locate and clear or obtain approval to use, assets in the advertisement.

As further illustrated in FIG. 1 and described in more detail below, the automated advertisement system 100 may implement, such as by the server 100, an AI engine 104A, which may comprise one or more modules including but not limited to an asset selector 104B and an advertisement creator/simulator 104C. The asset selector 104B may be configured to match data in the advertiser profile 106A and/or the project profile 106B to data in assets 106C. The advertisement creator/simulator 104C may be used to create and/or simulate advertisements using the selected asset from the asset 106C database or database, and such created and/or simulated advertisements may be stored in the advertisements 106D database or database.

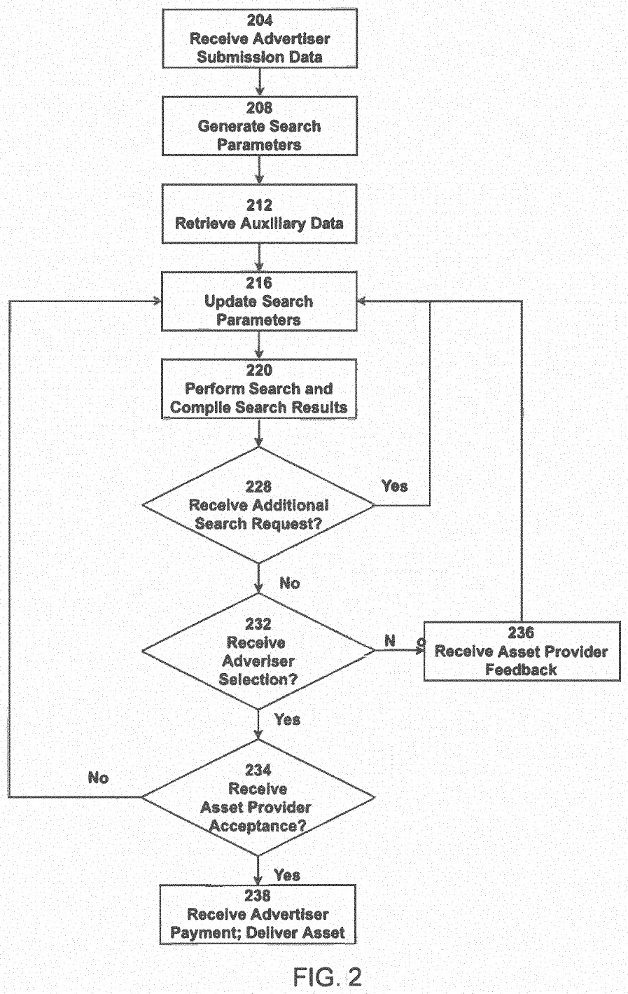

FIG. 2 is a flow diagram of one exemplary method of the automated advertisement system 100 from the advertiser-end. An advertiser may be any individual or entity in need of an advertisement. Such an advertisement may include any form of media requiring an asset. Assets may be in any form of media, including but not limited to videos, images, audio, etc., and may include a variety of subjects, including but not limited to humans, animals, objects, locations, properties, etc. For example, an advertiser may want to create a video-format pet shampoo advertisement and may require a video of an animal to represent the pet and a video of a human to represent the pet owner. The advertiser may also wish to obtain images of the animal and human for a promotional poster, and audio files of the animal and human for a promotional radio advertisement. The video and radio advertisements may also include audio assets, such as dialogue, music or the like. In another example, an advertiser may want to promote a travel agency, and may want to obtain assets in the form of images of various locations a tourist may wish to travel to.

In a step 204, an advertiser may connect with the automated advertisement system 100 via an advertiser device 110 to enroll in an advertiser account, and to submit data. Data may include information for a general advertiser profile, including but not limited to profile information (such as name, location, payment accounts etc.), official websites and company profiles, and social media accounts. Data may also include information for an advertisement project, including but not limited to the nature of the advertisement, the intended audience, the specific requirements for assets, etc.

In one embodiment, in addition to a general advertiser profile, the advertiser may create one or more project profiles. A project profile may include information, such as criteria for, a particular advertising project. For example, an advertiser might create a first project profile for a dog shampoo advertisement, and a second project profile for a cat food advertisement. Each of these advertisements might have different associated criteria. In one embodiment, the automated advertisement system 100 may use the advertiser's profile, past project profiles, and/or auxiliary data to auto populate and/or suggest one or more criteria in new projects, and may predict and/or suggest assets.

In a step 208, general search parameters may be generated based on the submitted data. This data might comprise: 1) the project profile data, 2) the advertiser's profile data, and/or 3) other or tertiary information, such as information regarding any past projects the advertiser may have created and stored in the automated advertisement system database 106. In a step 212, auxiliary data may be retrieved. In a step 216, auxiliary data may be used to update search parameters.

As discussed in FIG. 1, the automated advertisement system 100 may access auxiliary data and metadata 130 via the network 140. Auxiliary data may include any information related to the advertiser. In the example of a pet shampoo company in search of assets for a pet shampoo advertisement, auxiliary data may include the pet shampoo company's social media profiles, company connection graph, customer profiles, social media information, company profiles containing news and press releases, searches in news and other information databases for news relating to the pet shampoo company, and any other type of publicly available information. For example, where the specific requirement for an asset representing a pet owner may not include specifications for the actor's age, but where a recent press release indicates the company is actively promoting pet products towards older customers, the search parameters may be updated to weight search results for assets involving older actors differently than assets involving younger actors.

In one embodiment, projects may have profiles with attributes that may be self-selected and automatically created through analysis of advertiser data and behavior. For example, an advertiser may be a company in the healthcare industry who wishes to create a project for an advertising campaign for an insurance plan. The project profile may include, but is not limited to, data such as date(s), time(s), location, assets sought and budget. The advertiser may optionally link its social media accounts. Attributes may be automatically added and/or updated for the project profile and/or the advertiser profile through analysis of the advertiser's social media, digital footprint including company website, news articles, other online mentions, and associated pictures, videos and text about the company. Further, attributes may be automatically added and/or updated for the project profile and/or the advertiser profile through analysis of the advertiser's use of the automated advertisement system 100, such as how long the advertiser views each asset's profile, which assets the advertiser has shortlisted, held or been booked, and the advertiser's rating by the assets it has booked.

In a step 220, one or more searches may be performed in the database 106 to identify available and matching assets, and search results may be displayed to the advertiser. Where multiple types of assets are requested (such as a pet and a pet owner), more than one search may be performed and one more than set of results may be displayed.

The search results may be displayed using a gamified optimization algorithm, so that the advertiser may see assets not in the order of best-to-worst results (based on matching of specific requirements), but instead, in an order that maximizes the probability that the advertiser finds one or more assets they will choose and/or maximizes the feeling of success in using the system.

In one embodiment, the system may generate an initial set of search results, such as 5-10 search results. The advertiser may select or reject individual search results. As the advertiser selects or rejects individual search results, the results may be updated to include new/additional results. For example, assume that the advertiser is looking for images of a dog. A first set of images may be presented. The advertiser may reject the first image of a white dog, but select second and third images of black dogs. Based upon the advertiser's indications, the system may be configured to supplement or update the results to include additional images of black dogs and/or remove images of white dogs.

In another embodiment, an advertiser may be permitted to select a particular asset and then see all related assets. For example, an advertiser may select from the search results an image of a black Labrador puppy. The advertiser might select a “see related” feature to see all assets of that same puppy, such as other images of the puppy (taken in different locations, at different times), videos of the puppy, etc. As another example, an advertiser might be permitted to select a particular asset and then see all similar assets. For example, an advertiser may select from the search results an image of a black Labrador puppy. The advertiser might select a “see similar” feature to see all assets of black Labrador puppies (including ones other than the selected one).

In an optional step 228, the advertisers may refine the search (such as via the submission of additional data, as described in step 204). An asset compilation module may be configured (based on default settings or user preference settings) to display assets individually, or compiled in a pre-made advertisement form (such as a brief video showing a pet owner giving the pet a bath using shampoo). In the latter case, the advertiser may be given the option to isolate portions of the pre-made advertisement. The isolated portion may be designated as a selected asset, and the user may request additional results to be displayed for the non-selected assets. In another embodiment, the isolated portion may be used to refine searches. For example, the advertiser may isolate the pet in the pre-made advertisement and request a search for similar pets. The advertiser may also manually input additional search criteria such as “a similar-looking dog, but with white fur”.

Alternatively, in a step 232, the advertiser may identify that no assets are usable. In a step 236, the advertiser may be prompted to provide feedback to refine the search. For example, the advertiser may identify that all the results for pet assets may be cats (based on the advertiser's auxiliary data), and submit a request that, for this project, dogs are desired.

If the advertiser identifies one or more assets as usable, then in a step 236, the asset provider is notified of the advertiser's request to use the asset. For example, upon identifying the desired dog asset, the asset provider may be the dog owner, who may be notified of the advertiser's request to use that asset and be given the opportunity to reject the request. If the asset provider rejects the advertiser's request, then the search results may be further refined to remove that particular asset, or all assets by that particular asset provider.

If, on the other hand, the asset provider accepts, then in a step 238, payment may be delivered to the asset provider, and the asset is delivered to the advertiser. In one embodiment, the advertiser may make special requests for assets to an asset provider. For example, if the advertiser wishes to create an advertisement poster for an animal shampoo using the front view of a dog's face, and identified a desired dog asset, but the asset is a side-view of a dog, the advertiser may request the asset provider provide a front view image of the dog instead. In another embodiment, the advertiser may request alternative searches be performed on the asset provider's social media to identify existing images of the dog, and to retrieve an image involving the front view. In one embodiment, assets may be delivered to the advertiser by transmitting them to the advertiser. In another embodiment, the assets may simply be associated with the advertiser's account (e.g. linked from the database 106 to the advertiser's account as having been accepted/paid for, and thus usable by, the advertiser). In other embodiments, the asset may be associated with one or more advertisements which are provided to or accessible by the advertiser.

Many steps in this flowchart may be iterative. For example, steps 212 to 216 may be repeated as many times as needed, such that new auxiliary data may be periodically retrieved, and search parameters may be updated in real time, particularly if the advertisement project is on-going, or the advertiser has not obtained all the asset the advertiser needs for the advertisement project. Steps 216 to 228 may be repeated as many times as needed until an advertiser stops requesting additional searches. Steps 216 to 236 may be repeated as many times as needed until an advertiser finds a desired compilation of search results.

The automated advertisement system allows asset providers to quickly and easily create profiles for themselves or property they own (including but not limited to places, pets and objects) that are available through an online digital marketplace for advertisers and their agents to find. The profiles can include social media accounts which show the assets in more natural settings with timestamps so that interested parties can get a more realistic view of the asset over time and into the present. The automated advertisement system allows asset providers to choose open projects to apply to, which are ranked based on an artificially-intelligent algorithm which matches the asset to the project, and weights the matches. The matches are shown using a gamified optimization algorithm, so that the user may see projects not in highest-to-lowest matching, but instead in an order that maximizes the chance the user finds one or more projects to apply to and/or maximizes the feeling of success in using the system.

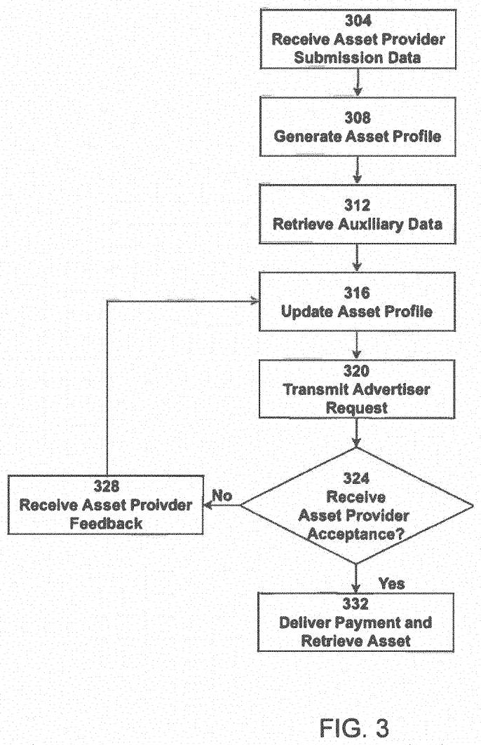

FIG. 3 is a flow diagram of an exemplary method of the automated advertisement system from the asset provider end using passive matching. In a step 304, an asset provider may connect with the automated advertisement system 100 via an asset provider device 120 to enroll in an asset provider account, and to submit data. Data may include information for a general asset profile for each asset the provider wishes to provide, including but not limited to profile information (such as asset name, asset category, asset location, etc.) and one or more displays of the asset, which may include any form of media (such as image, video, audio), as well as social media accounts. In one embodiment, the asset provider may manually select identification tags for the assets (such as the following tags for a dog video: “dog”, “animal”, “video”). The asset provider may also select restrictions for advertisers (such as a dog video only be used in advertisement created by advertisers identified as cruelty-free).

In a step 308, a general asset profile may be generated based on the submitted data. In a step 312, auxiliary data may be retrieved. In a step 316, auxiliary data may be used to update search parameters. On the asset end, auxiliary data may include any information related to the asset or asset provider. For example, if the asset is an Instagram model, auxiliary data may include images and videos retrieved from all social media accounts identified with the Instagram model, as well as other social media posts or news history associated with the asset. The asset's profile may be updated with such additional images and videos and their respective timestamps to display the asset in a plurality of environments, to provide a more realistic view of the asset, as well as any changes over time. Any negative news may be identified for advertisers who submitted specific requests for public image or perception. For example, an Instagram model identified with controversial political views may not be matched with advertisers or advertisement projects with specific requests for assets with no public controversies. Steps 312 to 316 may be iterative such that auxiliary data may be periodically retrieved, and the asset profile may be updated in real time, for as long as the asset is identified as available for matching.

In one embodiment, asset account profiles may include attributes that may be self-selected or automatically created through analysis of the asset's data and behavior. For example, an asset may be a 65-year-old man from Los Angeles, who created an asset account with links to his social media accounts. He may select one or more attributes, including but not limited to his height and weight. The automated advertisement system 100 may gather, through analysis of auxiliary metadata such as the asset's social media pictures and videos, additional asset attributes (such as hair color), or further refine the attributes (such as the asset's current weight based on his latest social media posts, compared to the weight an asset may have selected at the time of account registration). The asset's hobbies, interests, work, favorite topics and social manner may also be analyzed through analysis of his social media. Additionally, the asset's use of the automated advertisement system 100 may be analyzed to further supplement his attributes, including how long the asset looks at each project, which project he has been shortlisted for, held or been booked, and his rating by the projects he has booked.

In a step 320, if the asset is matched with an advertisement project and selected for use, a request to use the asset may be transmitted to the asset provider. In a step 324, the asset provider may reject the request. In a step 328, upon rejection, the advertiser may be notified that the asset is not available, and the advertiser's search results may be updated to remove the asset, or all assets by the asset provider submitting the rejection. At the same time, the asset profile may be updated to no longer be matched with similar-type advertisers or advertisement projects, or the asset provider may manually input additional criteria to refine future matching.

If, on the other hand, the asset provider accepts the request, then in a step 332, payment may be delivered to the asset provider, and the asset may be retrieved and delivered to the advertiser. In one embodiment, the asset provider may permit automatic retrieval of the asset without confirmation of acceptance, in which case steps 320 to 328 may be skipped.

Depending on the asset provider's settings and/or the advertiser's request, an asset may be used only in one advertisement project or only by one advertiser (such as purchasing an NFT or any other type of exclusive right), or an asset may be used in multiple advertisement projects or by multiple advertisers.

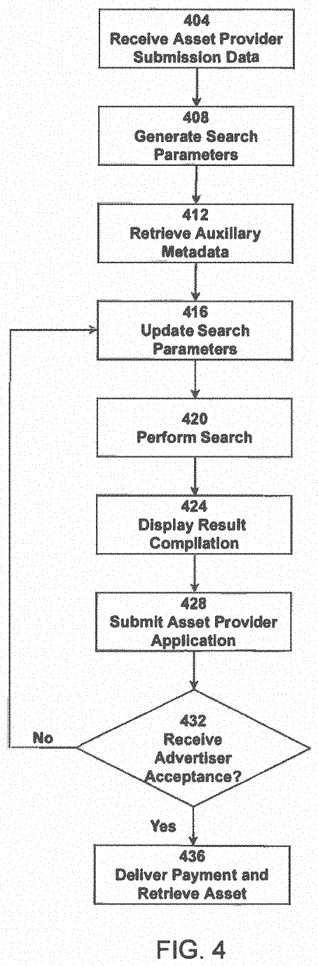

FIG. 4 is a flow diagram of an exemplary method of the automated advertisement system from the asset-end using active search. In contrast to the passive search discussed in FIG. 3, an asset provider may also perform active searches for matching advertisement projects. In a step 404, an asset provider may establish an asset profile as discussed in steps 304-316 above. In a step 408, the asset provider may submit additional data for a search. For example, where an asset provider established an asset profile for an image or video of a dog, the asset provider may request a search for all advertisers in need of dog assets. In a step 408, general search parameters may be generated based on the submitted data and any past projects the asset may have been used in. In a step 412, auxiliary data may be retrieved. In a step 416, auxiliary data may be used to update search parameters.

Auxiliary data may include any information related to the asset provider or the asset. For example, based on the asset provider's social media use, the asset provider may be identified as an advocate for animal rights. Search parameters may thus be updated to weight search results for advertisers identified as cruelty-free differently than advertisers not identified as such.

In a step 420, one or more searches may be performed in the database 106 to identify available and matching advertisement projects, and search results may be displayed to the asset provider. In one embodiment, the search results may also be displayed using a gamified optimization algorithm (as discussed in FIG. 2 step 220).

In a step 428, the asset provider may identify one or more advertisement projects that are desirable, and may submit an application for the advertiser to use the asset. In a step 432, the asset provider may reject the application, in which case, the search parameters may be updated to remove the advertisement project or all projects by the advertiser from matching. If, on the other hand, the advertiser accepts, then in a step 436, payment may be delivered to the asset provider, and the asset may be delivered to the advertiser.

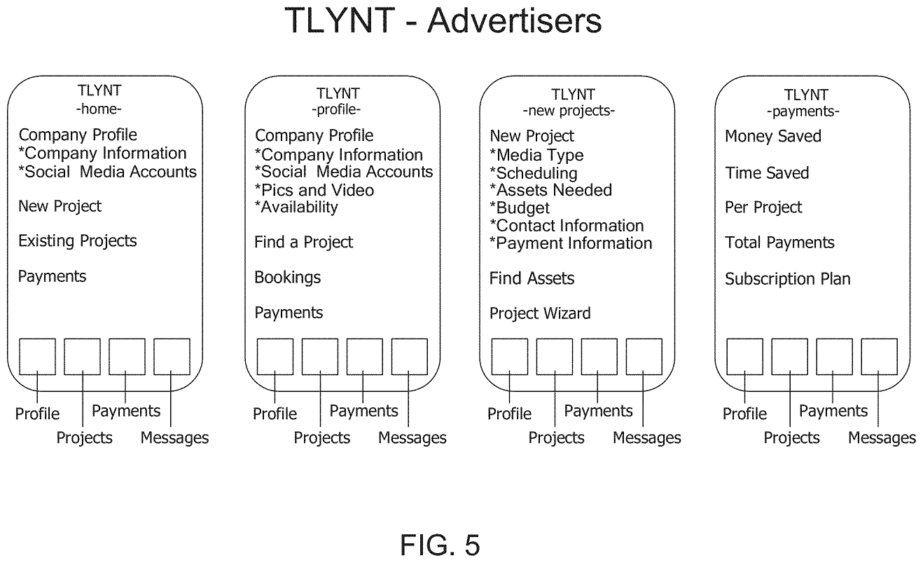

FIG. 5 illustrates exemplary user interfaces for an advertiser account. Notably, advertisement projects may be sorted by a plurality of options including but not limited to media type (such as image, video, audio, etc.), scheduling, assets needed, and budget.

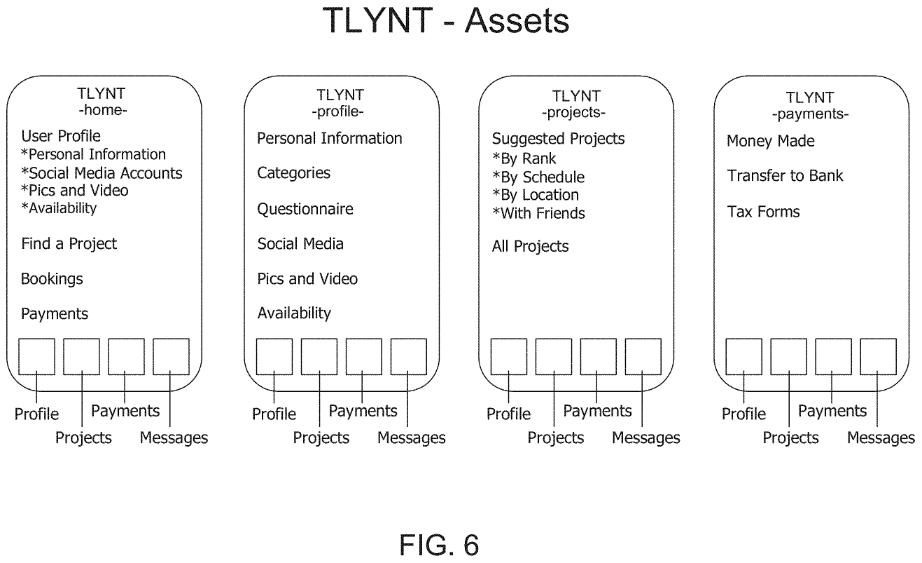

FIG. 6 illustrates exemplary user interfaces for an asset provider account. In addition to the passive and active matching illustrated in FIGS. 3 and 4, the asset provider account may include a “Suggested Projects” page, which may automatically display matching advertisement projects, and may be sorted by a plurality of options.

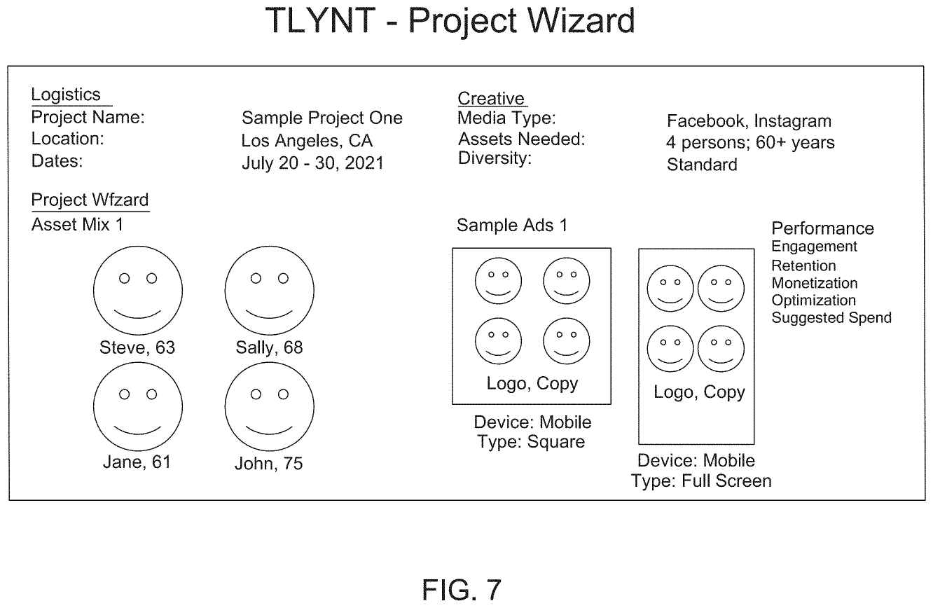

FIG. 7 illustrates exemplary user interface for advertisement creation (“Project Wizard”), which may be accessible via one or more advertiser account pages. The user interface may include one or more advertisement samples and/or digital storyboards, which may be automatically generated using default templates, or may be customized for advertisers. In one embodiment, the digital storyboard may include one or more options for assets, such that an advertiser may select and/or mix and match assets. One or more project profile summaries may be displayed above the asset options. Advertisers may save entire storyboards, or asset mixes (selection and/or combination of desired assets), or save individual elements of the asset mixes.

In one embodiment, asset mixes may be iteratively created and optimized by individual asset performance in digital campaigns (including but not limited to the performance of an individual asset, a combination of more than one assets, as used in previous advertisements, and/or assets' social media reach). The asset mixes may include information of such past performance so that advertisers may use that information to inform creative decisions and budgets.

Advertisers may also rate each element of the asset mix. Such ratings may be used to update one or more matching and/or searching algorithms used by the AI engine 104 and/or the automated advertisement system 100.

In one embodiment, asset mixes may be automatically added to digital advertisement templates, and digital agreements may be automatically generated and/or processed (discussed below), to create fully licensed advertisements that may be distributed online.

The Project Wizard may be fully integrated with one or more news, website, or social media platforms, and may use auxiliary data from the integrated sources to optimize advertisement templates. As shown in FIG. 7, for example, where an advertisement project identifies its primary audience as Facebook and Instagram, a performance rating may be assigned to the sample advertisement and its underlying assets, which may rate the sample based on a number of performance categories including but not limited to user engagement, audience retention, viability for monetization, and level of optimization. Performance ratings may be generated based on existing data of similar advertisement projects, assets, and general user data.

The advertiser may modify the advertisement sample, and the performance ratings may be updated in real time based on such modifications. Based on the performance ratings, the Project Wizard may also make one or more recommendations, such as a suggestion for lower spending due to limited monetization options.

Using digital graphics technology, such as including augmented reality software, selected assets may be digitally combined in a manner that makes it appear that they appeared together in a photo or video shoot. In this respect, individually selected assets are preferably combined or assembled, to create an advertisement. The configuration of the advertisement may depend, for example, on the project profile or other information. For example, based upon the project profile identify the project as a still image advertisement involving a dog getting shampooed in a outdoor tub, the assets might comprise a video of a dog getting shampooed, an image of a steel water tub, an image of a backyard, and one or more children. The video may be modified so that the dog appears to be standing in the tub, in the back yard, with the children in the area. In some embodiments, templates or layouts may be selected and utilized to aid in the creation of the advertisements, including the association of the assets. Preferably, the server 104 is configured to automate the creation of the sample advertisement using the assets.

As discussed previously, where an advertiser retrieves an image from an asset on a social media platform (such as the front view of a dog in a posted picture on Instagram), the advertisement creation tool may isolate the asset from the background to be used in the advertisement sample. Assets may also be digitally manipulated (such as digitally altering a model's age, turning real images into cartoon images, creating virtual 2D or 3D backgrounds). Thus, a plurality of advertisements can be created using the set of assets, but customized to appeal to different demographics, then tested on social media and digital ad platforms to determine the engagement of each.

For example, where the advertiser may wish to create an animal shampoo advertisement, one advertisement may be created using the asset of a native image of a man in his mid-30 s representing the pet owner for an advertisement to be published on Twitter, where the user demographic may be identified as having an average age of 30. A second advertisement may be created using the same asset, but digitally modifying the image to appear as a man in his mid-50 s for an advertisement to be published on Facebook, where the user demographic may be identified as having an average age of 50.

In one embodiment, the Project Wizard may automatically begin simulating one or more advertisement projects as the advertiser is creating the project profile using suggested assets based on existing search criteria. Each additional search criteria the advertiser enters may result in modifications to the simulation, such that the advertisement creation process becomes dynamic, and suggested assets may inspire further creation and/or modification to a simulated advertisement.

In one embodiment, upon creation, proper licensing, and publication of the created advertisement, the advertisement may distributed through digital campaigns, with engagement, retention and monetization of each campaign informing the rating for each asset mix. The ratings for each asset mix are, in turn, used to update the weights for the individual assets and relationship between the asset and the project (discussed more below).

Further, the performance rating may be converted to real-time tracking of statistics associated with the advertisement (such as actual user engagement, audience retention, etc.). These new statistics may, in turn, be used to calibrate performance ratings for future advertisement projects. Further, the highest performing advertisements may be identified for the advertiser, who may wish to reshoot the advertisement by professionals to add additional “polish” to the product, with the knowledge from the user engagement data that their target audience resonates with the underlying assets and overall presentation.

Where the advertiser and/or the asset provider provided social media accounts, depending on user settings, created advertisements may be automatically pushed to their respective social media accounts as a new post, or the advertiser and/or the asset provider may be provided with customizable links or templates to create their own social media posts. The newsfeed templates may include social media tags or handles of all parties involved. For example, the advertiser's Twitter account may publish a Tweet with an embedded advertisement video, as well as links to the Twitter account of all models used in the video. Similarly, the models' Twitter accounts may publish a Tweet with the embedded advertisement video, as well as links to the Twitter account of other models and the advertiser. The respective followers of each Twitter account may then be able to “re-tweet” the newsfeed, thereby spreading the advertisement video across a wide network of Twitter accounts.

Thus, the advertisement may be promoted on social media networks associated with multiple user accounts, thereby maximizing exposure. Further, the promoted advertisement will not only promote the advertiser's product or services, but also the assets used in the advertisement, thereby benefitting all parties involved and incentivizing active participation.

The asset providers may not only receive exposure from the advertisement itself, but may be further incentivized to help promote the advertisement by receiving a portion of the advertisement revenue based on exposure traceable to the asset provider's promotional activities.

Simultaneously, the promoted advertisement may include watermarks or links to the automated advertisement system 100, thereby promoting the system itself.

In addition, the automated advertisement system 100 streamlines the licensing process of creating an advertisement. Electronic contracts and non-fungible tokens can be used to track the relationships over time, including the ads that are created, to pass value based on terms agreed to by the users. Through user acceptance of terms and services, and the automated delivery of any additional legal documents, the automated advertisement system 100 may create advertisements with underlying rights secured.

The automated advertisement system 100 may be used to create advertisements for social media platforms, live streaming platforms, content creation and publication platforms, email marketing campaigns, etc. Advertisements may be made in any media form including but not limited to images, videos, audios, pop-up promotions, website banners, etc.

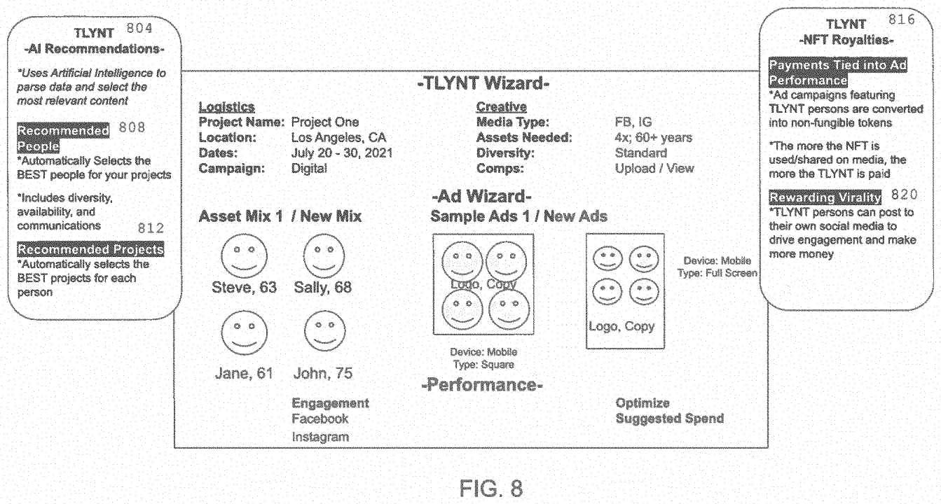

FIG. 8 illustrates exemplary user interfaces for the AI recommendation page and the NFT royalties page. In one embodiment, one or more AI engines (illustrated as 104A in FIG. 1 and discussed above) and/or AI modules may be used to parse data and select the most relevant content for any user. Such relevant content may appears on an AI recommendation page 804, which may begin to auto populate with project and asset recommendations based on an advertiser's input of one or more search criteria. One or more AI engines (illustrated as 104A in FIG. 1 and discussed above) and/or AI modules may be used to parse data and select the most relevant content.

For advertisers, the AI recommendation page 804 may include recommendation for assets 808. Asset recommendation may be based on asset attributes (discussed above) that match the project attributes (discussed above) of the projected created by the advertiser. Such attributes may include but are not limited to attributes such as demographics, work/hobbies/interests, reliability, physical appearance, recent photographs and videos, social media reach, diversity, availability, and locations. Specifically, the one or more AI engines or AI modules may assign a weight for each asset relative to a project. These weights may change over time, as informed by the profile changes in the projects and assets, and informed by the interaction between the project and asset. For example, a project may request a questionnaire, survey or interview from an asset. The results of that interaction may impact the asset-to-project weighting. If the weight of an asset indicates the asset is suitable for the project, then the asset may appear on the AI recommendation page 804. As discussed previously, a gamified optimization algorithm may be used to determine which assets may be recommended.

Similarly, for asset providers, the AI recommendation page 804 may include recommendation for projects based on the dynamic weight of projects relative to an asset 812.

As discussed above, assets may be in any electronic or digital format. Where an asset is a non-fungible token (NFT), the advertisement created with such NFT assets (whether the advertisement itself may be an NFT or not) may be added to the blockchain to allow for tracking of engagement and payment to underlying assets (such as in the form of royalties, as discussed above).

For example, a digital advertisement may be created with a first NFT asset and a second NFT asset. The asset provider of each NFT asset may, via a digital agreement, which may be provided by the automated advertisement system 100 and may include but is not limited to any type of licensing agreement, assignment, or other types of transfer of rights, grant the advertiser of the digital advertisement the rights to use the asset. The digital agreement may include the terms for payments for each NFT asset (such as, for example, a payment of $10 to the asset provider of the first NFT asset per thousand views of the digital advertisement, and a payment of one large bag of pet food to the asset provider of the second NFT asset per thousand views of the digital advertisement). The digital agreement may be added to the blockchain.

The digital advertisement may be distributed through organic and paid placement on digital distribution channels such as on social media and websites, or via press releases and interviews. The automated advertisement system 100 may measure the engagement of each advertisement using its one or more AI engines or modules, and/or using third party data (such as Facebook Insights providing performance of an advertisement on Facebook). Information related to the engagement may then be attached to the blockchain for the digital advertisement, and may be used to calculate payment to the asset providers pursuant to the digital agreement.

In one embodiment, the advertisement itself may be created as an NFT, and may be added to the blockchain to allow for tracking of engagement and payments.

As discussed above, asset providers may use their own efforts to push engagement numbers higher for advertisements using the assets provided by the asset providers. Such efforts may include but are not limited to buying copies of the advertisement, promoting the advertisement on their own social media accounts, and/or arranging their own press releases or interviews.

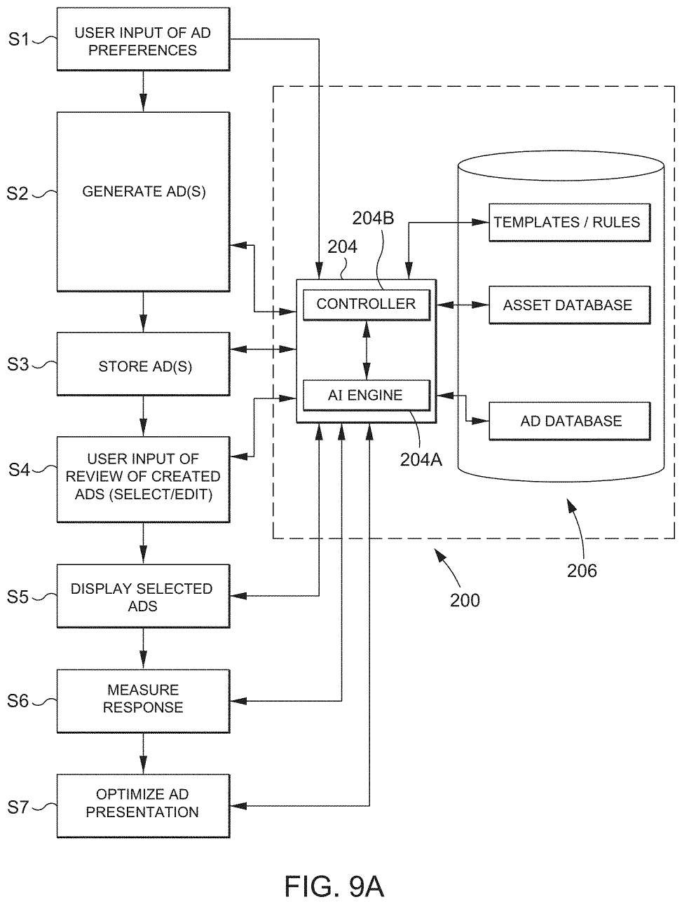

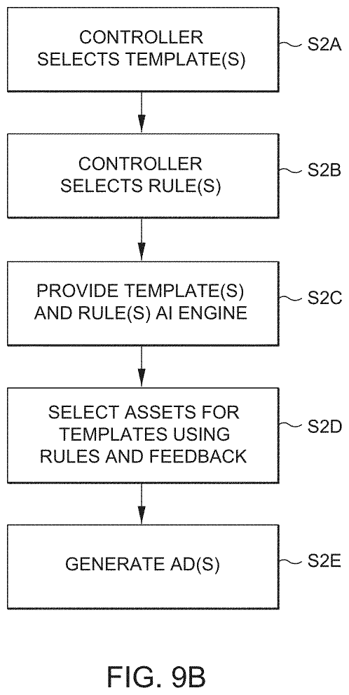

Aspects of another example of the invention will be described with reference to FIGS. 9A-B, 10A-B, 11 and 12. In this example, the invention again comprises a machine-implemented method for generating one or more advertisements, with an emphasis upon predictive formulation of advertisements having features or elements which are associated with or identified by tags, and where the process of generating ads is modified, such as based upon monitored engagement of displayed ads, for use in optimizing the advertisement creation process.

Referring first to FIG. 9A, an automated advertisement system 200 is again provided. While not shown, this system 200 may again include one or more user workstations or other elements, and may link to various other devices or systems, such as via a network (similar to that shows in FIG. 1 and described above).

In this embodiment, the automated advertisement system 200 comprises a generator 204 and one or more associated data storage devices or databases 206. The generator 204 preferably implements a model-driven advertisement generation tool. The generator 204 may comprise a controller or processor 204B, such as of a server or other computing device, which is configured to execute machine-readable code or software for implementing one or more functions herein. The generator 204 also comprises an AI engine 204A. The AI engine 204A might be implemented as software running on the controller 204B, or might be implemented as a remote engine, such as a third party AI engine (such as, but not limited to OpenAI, Google AI, IBM Watson, ChatGPT, Midjourney, etc.). In such a configuration, the controller 204B may communicate with the remotely implemented AI engine 204A, such as through one or more networks.

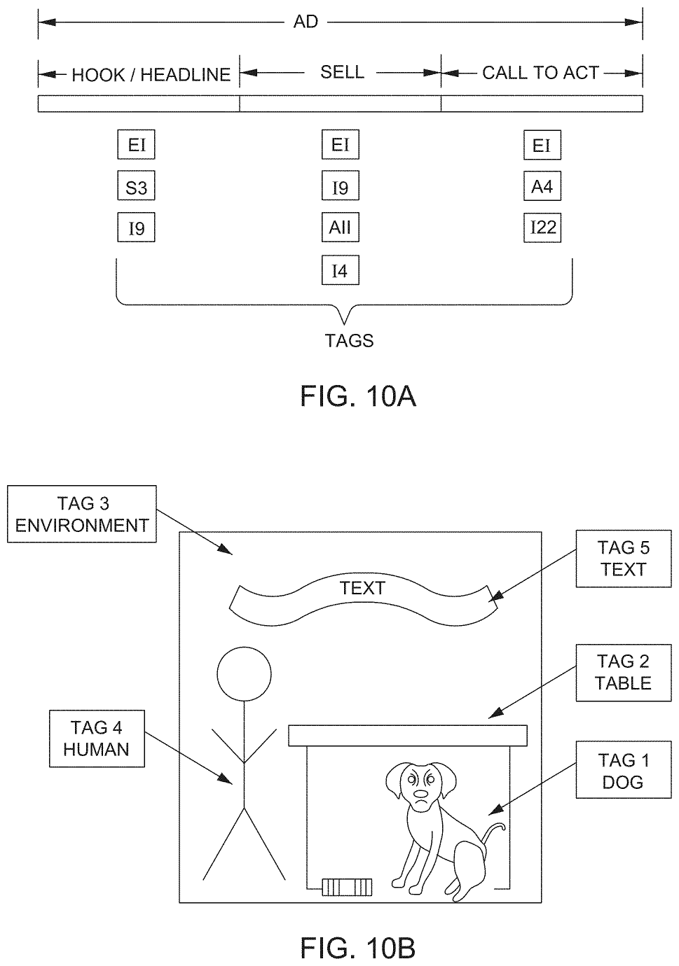

In this example, advertisements are defined by tags. The tags identify particular elements or features of the ad, such as specific advertisement assets and associated ad characteristics. FIGS. 10A and 10B illustrate aspects of an advertisement in accordance with this example of the invention.

As illustrated therein, an advertisement may have a plurality of characteristics. These may include particular assets which are used to create the advertisement, but also a temporal component, a spatial component and other characteristics or features. In particular, while an advertisement may be constructed from a plurality of assets, those assets may vary over time. For example, as illustrated in FIG. 10A, an advertisement might have a first temporal component which comprise a “hook” or “headline” portion of the advertisement (which may show or run for a particular period of time), a “sell” portion of the advertisement, and then a “call to act” portion of the advertisement. Of course, the advertisement might have other portions, and the advertisement might be broken into various segments or sections, including down to the frame level or units of time (seconds, for example).

As illustrated in FIG. 10B, portions of the advertisement are defined by a plurality of associated tags, which tags identify particular advertisement elements, such as assets. For example, FIG. 10B illustrates a single frame of a generated advertisement. The advertisement comprises a background or environment, which may be defined by a first tag, such as the illustrated Tag 3 (which might, for example, define the background as an image of a kitchen wall of a house), and tags defining other aspects of the advertisement, such as images (such as Tag 1, which identifies an image of a particular dog, Tag 2, which identifies an image of a particular table, and Tag 4, which identifies an image of a particular human). Of course, as described below, the tabs might also define other aspects of the advertisement, such as associated audio, text, styles and the like, as further described below.

As indicated above, the elements that define the advertisement may change over time. FIG. 10A illustrates a simplified example showing how the features or elements of the advertisement may change at different times, as represented by different groups of tags that represent different elements or features of the advertisement, at different times.

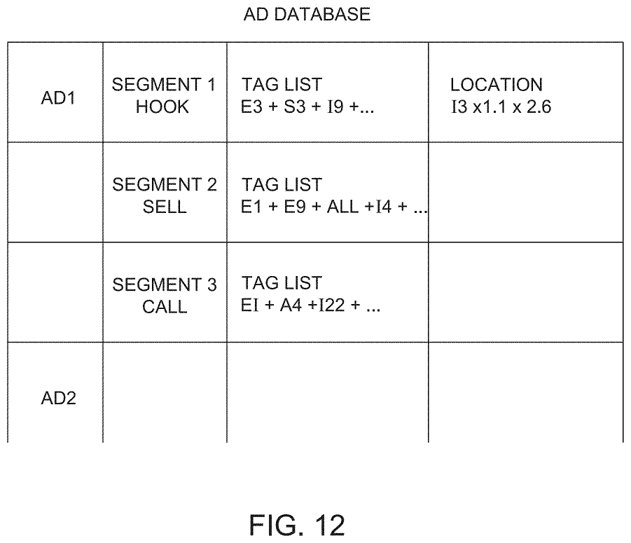

As described in more detail below, a particular advertisement may thus be defined by a plurality of different tags, which tags define not only associated assets, but other characteristics of the advertisement. For example, as illustrated in FIG. 12, an advertisement database may store information which defines an advertisement, such as advertisement AD1. The database stores information that defines the advertisement. This information may be stored in various manners, such as by linked data tables, linked data and the like. In the example, illustrated in FIG. 12, the tags which define the advertisement at different times are linked to one another and to a temporal portion of the advertisement. Further, information regarding the location (e.g. spatial component or relationship) of visually displayed assets may be associated therewith, such as by associating location with the tag which is linked to the designated asset. The location or spatial information may comprise, for example, coordinates for the tag (and thus associated asset) relative to the advertisement. This location information may change over time, such as when the location of the asset (e.g. dog moving through a kitchen) changes during the advertisement.

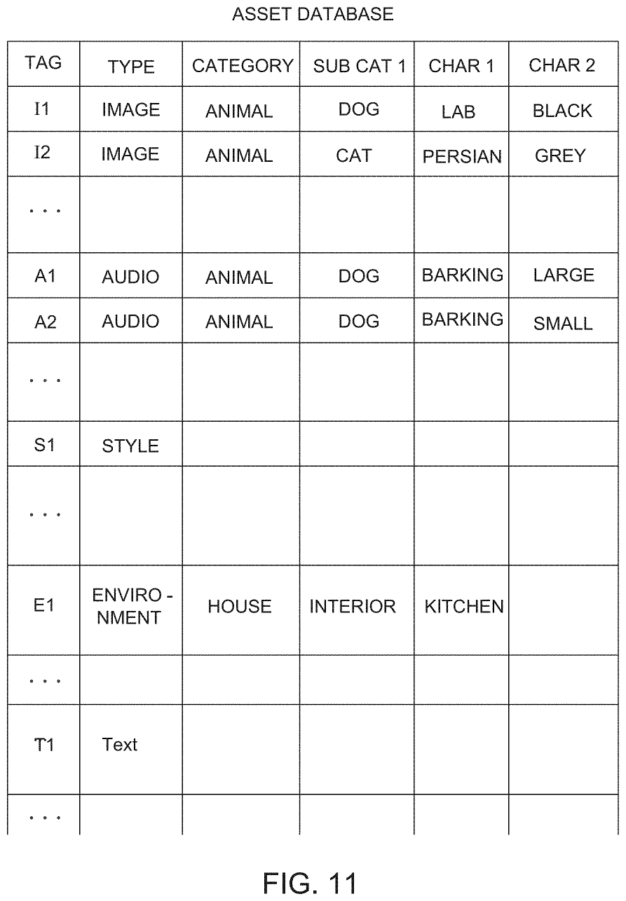

Referring to FIG. 9A, information which defines the elements or features of the advertisement (“ad assets”) may be stored in the database 206, such as an asset table or asset database. FIG. 11 illustrates one example of an asset table. The table may include tag identifiers. Each tag identifier is preferably unique, and is preferably associated with a unique asset or element. The tag identifiers may have various formats. In this example, the tag identifiers include an asset type identifier (such as I for an image asset, A for an audio asset) and then a numeric identifier. In one embodiment, the assets are identified by associated information, such as a category and one or more sub-categories. For example, an image asset might comprise a photograph of an animal (category), where the animal is a dog (sub-category 1), the breed is a Labrador (sub-category 2) and is black in color (sub-category 3). Of course, a wide variety of information regarding each asset may be linked to the tag and the asset. This allows the generator 204 to search the database for relevant assets to be used in an advertisement (e.g. if the generator 204 is looking for a picture of a black Labrador, searching for those terms will yield the asset with tag T1).

As indicated, when a tag is used in an advertisement, various information may be linked to the tag, such as the time the tag is used in the advertisement. For example, FIG. 11 shows an embodiment where the advertisement is broken into segments based upon time (in this example, three temporal segments, but it could be broken down into many segments) and then the tags that define advertisement during those segments are linked to those times. In other embodiments, tags may be generated for other characteristics of the advertisement and then those tags may be linked. For example, the advertisement might be broken down into time segments S1-S60 for a 60 second advertisement (each segment being 1 second long), so that the advertisement at time S=30 seconds might be defined by the tags S30 (defining time period S=30 seconds)/I2 (defining a particular image)/A1 (defining particular audio)/S9 (defining a particular advertisement style), etc. (where the other tags define assets or other characteristics of the advertisement at that time).

In this regard, tags might be used to define various (and preferably all) elements or aspects of an advertisement, or portions thereof, such as but not limited to: language, dialect, tone, style (writer, actor, celebrity, period in time/era, other content), direction (lighting, aspect ratio, shot types, angles, zoom/camera distance, audio, music, camera quality (homemade/professional), camera directions (focusing, etc.), audio quality (homemade/professional), editing (text overlay (position, color, font, size, titles, captioning, step-by-step, etc.), music, sounds effects, scene breaks, “punching In”, B-roll, etc.), styles (writer, actor, celebrity, period in time/era, other content), wardrobe, dancing, memes, movement, introduction/removal of elements, and various other elements. Again, these elements (characteristics, feature or attributes that define the advertisement) may be defined by tags or may be information that is linked to tags, such as in a table or other data structure that defines the advertisement.

Additional details of the automated advertisement system 200 and the operation thereof, will now be described.

As illustrated in FIG. 9A, in a step S1, the advertisement generator (or advertisement generation tool) 204 may be configured to receive input of advertisement preferences or features. These might be provided, for example, by an advertiser who desires to have one or more advertisements generated. For example, similar to that described above, this input might comprise a description (text/spoken) of features of a desired advertisement (e.g. “an advertisement for an offroad truck which is shown in the desert) or of elements thereof (e.g. “vehicle ad”, “desert”, etc.). Of course, the advertisement preferences might include a variety of information, such as information about the product or service to be promoted, the purpose of the advertisement or the intended response (Buy a Product, Use a Service, Feel an Emotion, Download an App, etc.), the target audience (Demographics, Psychographics, Age, Location, Behavior Type), but also aspects of the advertisement (such as described in more detail, aspects about the assets including images, text, audio and even aspects of the direction and editing).

In a step S2, the advertisement generator 204 uses the provided preference or feature information to generate one or more advertisements. One embodiment of a method of generating the advertisement will be described with reference to FIG. 9B. In one example, in a step S2A, the controller 204B selects one or more advertisement templates for use by the AI engine 204A in generating the advertisement. The controller 204B preferably selects the template(s) based upon the advertisement preferences or features. For example, basic templates may be generated for certain industries, products or the like. These templates may define basic features for the advertisement which are tailored for the particular industry, product or the like. These templates may be stored in the associated database 206. In some embodiments, the templates may be user generated, while in others they may be generated by an AI engine. In either case, the templates may be updated, such as manually or by the advertisement generator 204, such as based upon advertisement engagement information, as detailed below.

In a step S2B, the controller 204B selects one or more rules for the advertisement. These rules may again be selected based upon the provided preference or feature information and might be implemented relative to particular industries or products. For example, if the user desires to have an advertisement for pet food, the rules might indicate that certain pets should not be used in the advertisement or that certain pets should be used in the advertisement. Again, these rules may change over time, such as based on industry trends, user feedback (such as advertisement engagement data) and the like.

For example, the rules may comprise tag selection information or other advertisement information. For example, for a desired advertisement, a rule may be provided that the advertisement should have a certain aspect ratio, etc. When this rule is used to generate the advertisement, the advertisement asset corresponding to that rule (such as a tag that defines the particular aspect ratio which is designated by the rule) may be used in the generation of the advertisement.

In a step S2C, the controller 204B provides the template(s) and rule(s) to the AI engine 204A for use by the AI engine 204A in generating the advertisement(s). It will be appreciated that in other configurations, the AI engine 204A itself may select the templates and rules, such as using the provided advertisement preference or feature information in relation to a set of templates and rules stored in a database. In this configuration, the AI engine 204A may be taught to select the appropriate template(s) or rules based upon the provided input.

In a step S2D, the AI engine 204A preferably selects assets (i.e. tags) for use in generating the advertisement(s) based upon the templates, rules and learned intelligence of the engine. In this regard, in one embodiment, the AI engine 204A may have a generator component and a discriminator component. Both of these components may be supervised or unsupervised (self-learning). In a preferred embodiment, the components are supervised. For example, in a preferred embodiment and as detailed further below, the generator portion of the AI engine 204A is trained by providing it with the templates, the rules, and advertisement feedback information.

In a step S2E, the AI engine 204A generates the one or more advertisements. In one embodiment, this may comprise the generator portion of the AI engine 204A generating one or more advertisements, and a discriminator portion reviewing those advertisements to discriminate those which are successfully generated and those which are not. As with the generator, the discriminator may be trained. For example, the discriminator may be provided with various advertisement examples, rules or the like which the discriminator then applies to a generated advertisement in order to determine if, at a minimum level, the generated advertisement is acceptable. For example, the discriminator may be taught that an advertisement for pet food should not include an image of a horse, as even though a horse may be classified as a pet, as it is not commonly a household pet to which pet food applies. Again, training of the discriminator portion of the AI engine 204A may also include feedback which is provide thereto. For example, a trend within a particular industry may be to not refer to a product using a particular term. The training of the discriminator may include this new industry standard, whereby the discriminator removes advertisements which are generated by the generator with that terminology.

Referring back to FIG. 9A, in a step S3, the one or more generated advertisements are preferably stored, such as in the database 206. Again, the stored advertisements may be only those which are generated by a generator portion of the AI engine 204A and which are then accepted by the discriminator.

In a preferred embodiment, the goal of training the AI engine 204A (including associated feedback) is to have the AI engine 204A successfully “predict” acceptable advertisements—in other words, successfully generate advertisements which are acceptable to use and successful in the marketplace (such as by measured engagement, as detailed below).

In one embodiment, to aid in the training of the AI engine 204A and to further ensure the success of the generated advertisements, in a step S4, the advertisements may be reviewed and/or edited by a human. For example, the AI engine 204A might generate 4 different advertisements in response to a user's input. An individual or a team might then review those advertisements to either further cull them down to a single advertisement or smaller set, and/or to make changes to the advertisements, such as to correct errors not detected by the discriminator. In one embodiment, these changes may be fed back to the AI engine 204A to further teach it regarding the criteria which are desired for the advertisement(s).

In a step S5, the one or more advertisements may be run or displayed, such as by one or more media channels. It will be appreciated that this step may be implemented in various manners which are well known in the art. For example, the advertisement might be presented on the Internet, via online applications such as social media applications, on cable or over-the-air television, on dedicated advertising displays, print media such as billboards, newspapers, magazines, etc. This step may thus include transmitting the advertisement from the database 206 to one or more remote locations or systems. For example, the advertisement might be generated in an HTML format and be transmitted to a remote webserver for access on the Internet.

In a step S6, advertisement response or advertisement “experience” information is collected. Again, the collection of advertisement view data is well known in the art. In general, for example, the advertisement response information may include the number of times the advertisement is viewed, the amount of time the advertisement is viewed, purchases made, and various other metrics.

In one embodiment, these metrics are used to gauge the effectiveness of the advertisement, and more particularly, portions or elements of the advertisement. That information is then used in a feedback loop, such as to create or revise templates and rules, and for input to the advertisement generator 204 for further teaching it.

In one preferred configuration, a weight or selection value is assigned to each tag. The value might be, for example, a value between and including 0 and 1 (although it could be other values, such as 0-10, 0-100, −1 (such as where a negative value comprises a ‘do not use’ value) to +1, etc.). In one embodiment, an assigned value or weight of 0 means that the tag should not be included in the advertisement and an assigned value or weight of 1 means that the tag must be included in the advertisement. Values or weights between 0 and 1 may be linearly proportional to the obligation to include or exclude the tag.

As one example, as noted above, each advertisement may be defined by a set of tags. Every time an advertisement is shown, its engagement is tracked. For example, as noted above, such engagement may include information regarding impressions, video metrics (completions, time watched, etc.), clicks, website/app visits, downloads, sales, etc. Preferably, this engagement is monitored or tracked along the entire path relating to interaction with the advertisement and the associated advertiser and the products and services, such as distribution platforms, partner websites and analytics tracking products. The engagement may be defined as a combination of the metrics, such as: Engagement(Ad_IG_021423_0211_Demo12)=Metric1+Metric2+Metric3 + . . . Then the determined engagement is linked to each tag of the advertisement, such as Tag 1 Engagement=Engagement(Ad_IG_021423_0211_Demo12) + . . .

In this configuration, the engagement value is scaled to have a value including and between 0 and 1. Further, in a preferred embodiment, tags may also include a similarity score, which score defines a similarity of the tag (and associated asset/element) to one or more other tags. Similarity score represents the relational overlap between tags, such that the tags themselves share the same or similar performance characteristics and do not have additive value when combined. The generated values may be overridden, such as based upon human review, feedback or input from the advertiser, and/or general industry data and the like (including advertiser data, social media data, sales data, channel data, distribution partner data, competitor data, etc.).

In one embodiment, tags may have a different weight or value depending upon their valued use, such as the nature of the advertisement (including the template that the tag is used with). For example, a tag which relates to an image of a dog might have a weight of 0.95 for a dog food advertisement, but only 0.65 for an advertisement for carpet cleaner.

As indicated, the tag values are preferably used in the generation of new advertisements (where the continued re-valuing of the tags based upon feedback relating to their use in specific advertisements changes the values of the tags over time in an iterative training process).

In the generation of a new advertisement, the generator 104 may be configured to use a combination of tags having high values or weights for similar uses as to the intended advertisement (e.g. as tied to the generation and selection of the templates and rules, and the “knowledge” of the AI engine 204A). Further, the AI engine 204A may create a plurality of alternative advertisements, such as by selecting alternate combinations of tags, such as by selecting other tags with high similarity scores, low similarity scores, etc. within categories and between categories.

In one embodiment, as illustrated in FIG. 9A at step S7, advertisement presentation may be optimized, particularly in relation to the presentation of more than one advertisement. For example, when multiple advertisements are generated, the different advertisements may be run on different channels to measure the engagement of the advertisement and the effectiveness of the tags. In this configuration, the measured engagement may be an engagement for a particular channel (e.g. TV vs. online). In one embodiment, advertisements may be run on a particular channel until measured engagement drops below a particular level (which may be referred to as a creative fatigue level). At that point, the advertisement might be run on a different channel until measured engagement again drops below the minimum set level.

The measured engagement information is used to update the tag values and is then reused in generating new advertisements in the process described above. This process may repeat, such as for a particular advertisement run time, until advertisement optimization is exhausted (e.g. measured engagement is not increasing even for newly generated advertisements as compared to earlier presented advertisements), until an advertisement budget is exhausted, etc.

In one example where the process of generating and presenting advertisements is based upon an advertisement budget, the process may be optimized to reach a critical threshold, such as point at which the lifetime value is greater than the cost of the advertisement or advertisement virality has been achieved (aka more people are seeing the advertisement than is being paid for). In some embodiments, the system may generate a suggested advertisement budget, based upon a calculated estimated cost necessary to reach the minimum engagement level.

It will be appreciated that this example of the invention may be combined with other features of the invention described herein. For example, this feature of the invention might be combined with the features described above for monetizing assets, whereby assets which are selected for use in generated ads may be tracked and the owner of the asset (such as an image) may be paid for use thereof.

It will be understood that the above described arrangements of apparatus and the method there from are merely illustrative of applications of the principles of this invention and many other embodiments and modifications may be made without departing from the spirit and scope of the invention as defined in the claims.

What is claimed is:

1. An intelligent system for generating an advertisement, comprising:
a data storage device;
digital information stored in said data storage device, said digital information comprising a plurality of advertising assets each designated by a tag; a plurality of advertisement templates; and a plurality of advertisement rules; and
a processing device, coupled to the data storage device, to execute a model-driven advertisement generation tool, wherein the advertisement generation tool is configured to:
receive input regarding one or more advertisement characteristics;
select one of said plurality of advertisement templates based upon said one or more advertisement characteristics;
select, using the advertisement template and one or more of said plurality of rules, a plurality of said advertising assets utilizing information associated with said tags; and
generate at least one advertisement utilizing said tags, said advertisement template and said one or more of said plurality of rules, wherein said at least one generated advertisement is defined by a relationship of said utilized tags.

2. The system in accordance with claim 1, wherein each tag has an associated selection value.

3. The system in accordance with claim 2, wherein each tag has a plurality of selection values in relation to said one or more advertisement templates.

4. The system in accordance with claim 1, wherein said model-driven advertisement generation tool is configured to select said tags at least in part based upon the selection values associated with said tags.

5. The system in accordance with claim 1, wherein said plurality of advertising assets comprise at least one of: a background, an image, a style, an environment, text, audio, and direction element.

6. The system in accordance with claim 1, wherein said at least one generated advertisement has a temporal component and said at least one advertisement is defined by a relationship of said utilized tags at different times.

7. The system in accordance with claim 1, wherein one or more elements of said plurality of advertisement rules are manually updated and one or more elements of said plurality of advertisement rules are updated based upon feedback provided to said system.

8. The system in accordance with claim 1, wherein said model-driven advertisement generation tool receives advertisement engagement information and utilizes said advertisement engagement information to update said plurality of advertisement rules.

9. The system in accordance with claim 1, wherein said advertisement engagement information comprises information regarding viewing of said at least one generated advertisement in at least one media channel.

10. The system in accordance with claim 1, wherein said model-driven advertisement generation tool comprises an AI engine.

11. The system in accordance with claim 10, wherein said AI engine comprises a generator component and a discriminator component, said generator component configured to generate one or more proposed advertisements using a first one or more of said plurality of rules, and said discriminator configured to determine acceptability of said one or more proposed advertisements as said generated advertisement based upon compliance with a second one or more of said plurality of rules.

12. The system in accordance with claim 2, wherein said model-driven advertisement generation tool receives advertisement engagement information received from presentation of said at least one generated advertisement and utilizes said advertisement engagement information to update said selection value for at least one tag utilized in said presented advertisement.

13. The system in accordance with claim 2, wherein said tags further comprise a similarity score, said similarity score defining a similarity of an asset associated with said tag in relation to at least one asset associated with another tag.

14. The system in accordance with claim 1, wherein said model-driven advertisement tool further implements an advertisement optimization engine, said advertisement optimization engine configured to receive advertisement engagement information received from presentation of said at least one generated advertisement and utilize said advertisement engagement information to modify said at least one generated advertisement by selection of one or more alternate tags to comprise the at least one generated advertisement.

15. The system in accordance with claim 1, wherein said plurality of advertisement templates comprise one or more templates which relate to a particular industry, product and/or service.

16. The system in accordance with claim 1, wherein said information associated with said tags comprises a plurality of characteristics of said asset.

17. The system in accordance with claim 1, wherein said at least one generated advertisement has a spatial component and said at least one generated advertisement is defined by a spatial relationship of said assets associated with said one or more selected tags.

18. A method of intelligently automating the generation of an advertisement, comprising:
providing a plurality of advertising assets each designated by a tag; a plurality of advertisement templates; and a plurality of advertisement rules;
receiving input regarding one or more advertisement characteristics;
utilizing a computer-implemented, model-driven advertisement generation tool to:
select one of said plurality of advertisement templates based upon said one or more advertisement characteristics;
select, using the advertisement template and one or more of said plurality of rules, a plurality of said advertising assets utilizing information associated with said tags; and
generate at least one advertisement utilizing said tags, said advertisement template and said one or more of said plurality of rules, wherein said at least one generated advertisement is defined by a relationship of said utilized tags.
